(19) United States
(12) Patent Application Publication
(10) Pub. No.: US 2025/0393020 A1
(43) Pub. Date: Dec. 25, 2025

(54) Communication Method and Related Apparatus

(71) Applicant: Huawei Technologies Co., Ltd., Shenzhen (CN)

(72) Inventors: Jingwei Zhang, Hangzhou (CN); Ying Chen, Hangzhou (CN); Tianhang Yu, Hangzhou (CN); Yunfei Qiao, Hangzhou (CN); Ruonan Yang, Shenzhen (CN)

(73) Assignee: Huawei Technologies Co., Ltd., Shenzhen (CN)

(21) Appl. No.: 19/307,434

(22) Filed: Aug. 22, 2025

Related U.S. Application Data
(63) Continuation of application No. PCT/CN2024/078222, filed on Feb. 23, 2024.

(30) Foreign Application Priority Data
Feb. 24, 2023 (CN) 202310209069.4

(51) Int. Cl. H04W 64/00

(52) U.S. Cl. CPC H04W 64/00

(57) ABSTRACT

The method includes: receiving a first configuration, where the first configuration includes a positioning parameter of a reference signal periodically sent by at least one of the first access network device and a second access network device; receiving a first reference signal from the first access network device, where the first reference signal is a reference signal sent by the first access network device in a first frame in at least two frames; receiving a second reference signal from the second access network device, where the second reference signal is a reference signal sent by the second access network device in a second frame in the at least two frames, and the second reference signal and the first reference signal are simultaneously sent; and sending a time difference of arrival between the first reference signal and the second reference signal to the core network device.

### CROSS-REFERENCE TO RELATED APPLICATIONS

This is a continuation of International Patent Application No. PCT/CN2024/078222 filed on Feb. 23, 2024, which claims priority to Chinese Patent Application No. 202310209069.4 filed on Feb. 24, 2023. The disclosures of the aforementioned applications are hereby incorporated by reference in their entireties.

### TECHNICAL FIELD

This disclosure relates to the field of communication technologies, and in particular, to a communication method and a related apparatus.

### BACKGROUND

A terminal device (for example, user equipment (UE)) may need to determine a location of the terminal device during use. For example, the UE may implement navigation, emergency calling, or the like through positioning. Currently, the terminal device may implement positioning by using an observed time difference of arrival (OTDOA) technology. The technology may also be referred to as downlink time difference (downlink time difference of arrival (DL-TDOA)). In this case, the terminal device mainly receives and measures reference signal time differences of arrival (reference signal time difference of arrival (RSTD)) of reference signals sent by several cells, and reports a measurement result to a network side or a positioning server. The network side or the positioning server positions the terminal device by using a known location of a network device and the plurality of RSTDs.

Due to differences in locations of different network devices, transmission delays of reference signals sent between the different network devices are different. Especially in a non-terrestrial network (NTN), a distance between satellites and a distance between a satellite and a terminal device are large, and there is a high transmission delay in reference signal transmission between the satellite and the terminal device. In addition, there is a high transmission delay between reference signals received by the terminal device from different satellites, and the transmission delay may exceed half a frame length. Therefore, two reference signals used for RSTD measurement are positioned in incorrect frames, leading to a problem of frame-level timing ambiguity. As a result, an error occurs in positioning of the terminal device.

### SUMMARY

Embodiments of this disclosure disclose a communication method and a related apparatus. In this way, a problem of frame-level timing ambiguity can be resolved, accuracy of determining a time difference of arrival between reference signals simultaneously sent by different access network devices is improved, thereby helping improve positioning accuracy of a terminal device.

According to a first aspect, an embodiment of this disclosure discloses a first communication method. The method may be applied to a terminal device, an apparatus (for example, a chip, a chip system, or a circuit) in the terminal device, or an apparatus that can be used together with the terminal device.

The method includes: receiving a first configuration from a first access network device or a core network device, where the first configuration includes a positioning parameter of a reference signal periodically sent by at least one of the first access network device and a second access network device; receiving a first reference signal from the first access network device, where the first reference signal is a reference signal sent by the first access network device in a first frame in at least two frames; receiving a second reference signal from the second access network device, where the second reference signal is a reference signal sent by the second access network device in a second frame in the at least two frames, and the second reference signal and the first reference signal are simultaneously sent; and sending a time difference of arrival between the first reference signal and the second reference signal to the core network device. In this way, the terminal device may determine a reference signal that is in the first access network device and/or the second access network device and that is processed and/or not processed by using the positioning parameter in the first configuration, thereby further determining reference signals simultaneously sent by the first access network device and the second access network device and their respective frames. In this way, a problem of frame-level timing ambiguity can be resolved, accuracy of determining a time difference of arrival between reference signals simultaneously sent by different access network devices is improved, thereby helping improve positioning accuracy of a terminal device.

With reference to the first aspect, in some feasible examples, the method further includes: determining the time difference of arrival based on receiving time of the first reference signal and the second reference signal and a second configuration. The second configuration includes a mapping relationship between reference signals simultaneously sent by the first access network device and the second access network device, and the second configuration is predefined or pre-configured, or is from the first access network device or the core network device. In this way, the terminal device may determine, by using the mapping relationship, the reference signals simultaneously sent by the first access network device and the second access network device and their respective frames, and further determine the time difference of arrival between the two reference signals, thereby improving accuracy of determining the time difference of arrival.

With reference to the first aspect, in some feasible examples, the method further includes: receiving a third configuration from the first access network device or the core network device. The third configuration includes a frame-level offset value between the first access network device and the second access network device. In this way, the terminal device may determine, by using the frame-level offset value, frames in which the first reference signal and the second reference signal are located, thereby improving accuracy of determining reference signals simultaneously sent by different access network devices, and helping improve positioning accuracy of the terminal device.

According to a second aspect, an embodiment of this disclosure discloses a second communication method. The method may be applied to a first access network device, or an apparatus (for example, a chip, a chip system, a circuit, or a network element) in the first access network device, or an apparatus that can be used together with the first access network device.

The method includes: sending a first configuration to a terminal device, where the first configuration includes a positioning parameter of a reference signal periodically sent by at least one of a first access network device and a second access network device; and separately sending a reference signal to the terminal device in at least two frames, where the reference signal includes a first reference signal sent in a first frame in the at least two frames. In this way, the terminal device may determine a reference signal that is in the first access network device and/or the second access network device and that is processed and/or not processed by using the positioning parameter in the first configuration, thereby further determining reference signals simultaneously sent by the first access network device and the second access network device and their respective frames. In this way, a problem of frame-level timing ambiguity can be resolved, accuracy of determining a time difference of arrival between reference signals simultaneously sent by different access network devices is improved, thereby helping improve positioning accuracy of a terminal device.

With reference to the second aspect, in some feasible examples, if the first access network device sends the reference signal based on the positioning parameter, a period of the reference signal is N times a source period. N is an integer greater than 1, and the source period is a period before the first access network device sends the reference signal based on the positioning parameter. In this way, after the reference signal is processed based on the positioning parameter, positioning processing is performed on some of the reference signals sent by the access network device, so that positioning can be performed based on the processed reference signal or an unprocessed reference signal, thereby helping improve accuracy of frame-level positioning.

According to a third aspect, an embodiment of this disclosure discloses a third communication method. The method may be applied to a core network device, or an apparatus (for example, a chip, a chip system, a circuit, or a network element) in the core network device, or an apparatus that can be used together with the core network device.

The method includes: sending a first configuration to a terminal device, where the first configuration includes a positioning parameter of a reference signal periodically sent by at least one of a first access network device and a second access network device; and receiving a time difference of arrival between a first reference signal and a second reference signal from the terminal device. The first reference signal is a reference signal sent by the first access network device in a first frame in at least two frames, the second reference signal is a reference signal sent by the second access network device in a second frame in the at least two frames, and the second reference signal and the first reference signal are simultaneously sent. In this way, the terminal device may determine a reference signal that is in the first access network device and/or the second access network device and that is processed and/or not processed by using the positioning parameter in the first configuration, thereby further determining reference signals simultaneously sent by the first access network device and the second access network device and their respective frames. In this way, a problem of frame-level timing ambiguity can be resolved, accuracy of determining a time difference of arrival between reference signals simultaneously sent by different access network devices is improved, thereby helping improve positioning accuracy of a terminal device.

With reference to the second aspect or the third aspect, in some feasible examples, the method further includes: sending a second configuration to the terminal device. The second configuration includes a mapping relationship between reference signals simultaneously sent by the first access network device and the second access network device. In this way, the terminal device may determine, by using the mapping relationship, the reference signals simultaneously sent by the first access network device and the second access network device and their respective frames, and further determine the time difference of arrival between the two reference signals, thereby improving accuracy of determining the time difference of arrival.

With reference to the second aspect or the third aspect, in some feasible examples, the method further includes: sending a third configuration to the terminal device. The third configuration includes a frame-level offset value between the first access network device and the second access network device. In this way, the terminal device may determine, by using the frame-level offset value, frames in which the first reference signal and the second reference signal are located, thereby improving accuracy of determining reference signals simultaneously sent by different access network devices, and helping improve positioning accuracy of the terminal device.

According to a fourth aspect, an embodiment of this disclosure provides a first communication apparatus. The apparatus may be a terminal device, an apparatus in the terminal device, or an apparatus that can be used together with the terminal device. The apparatus includes: a receiving unit, configured to: receive a first configuration from a first access network device or a core network device, where the first configuration includes a positioning parameter of a reference signal periodically sent by at least one of the first access network device and a second access network device; receive a first reference signal from the first access network device, where the first reference signal is a reference signal sent by the first access network device in a first frame in at least two frames; and receive a second reference signal from the second access network device, where the second reference signal is a reference signal sent by the second access network device in a second frame in the at least two frames, and the second reference signal and the first reference signal are simultaneously sent; and a sending unit, configured to send a time difference of arrival between the first reference signal and the second reference signal to the core network device.

With reference to the fourth aspect, in some feasible examples, the apparatus further includes: a processing unit, configured to determine the time difference of arrival based on receiving time of the first reference signal and the second reference signal and a second configuration. The second configuration includes a mapping relationship between reference signals simultaneously sent by the first access network device and the second access network device, and the second configuration is predefined or pre-configured, or is from the first access network device or the core network device.

With reference to the fourth aspect, in some feasible examples, the receiving unit is further configured to receive a third configuration from the first access network device or the core network device. The third configuration includes a frame-level offset value between the first access network device and the second access network device.

According to a fifth aspect, an embodiment of this disclosure discloses a second communication apparatus. The apparatus may be a first access network device, an apparatus in the first access network device, or an apparatus that can be used together with the first access network device. The apparatus includes: a sending unit, configured to: send a first configuration to a terminal device, where the first configuration includes a positioning parameter of a reference signal periodically sent by at least one of a first access network device and a second access network device; and separately send a reference signal to the terminal device in at least two frames, where the reference signal includes a first reference signal sent in a first frame in the at least two frames.

According to a sixth aspect, an embodiment of this disclosure discloses a third communication apparatus. The apparatus may be a core network device, an apparatus in the core network device, or an apparatus that can be used together with the core network device. The apparatus includes: a sending unit, configured to: send a first configuration to a terminal device, where the first configuration includes a positioning parameter of a reference signal periodically sent by at least one of a first access network device and a second access network device; and a receiving unit, configured to receive a time difference of arrival between a first reference signal and a second reference signal from the terminal device. The first reference signal is a reference signal periodically sent by the first access network device in a first frame in at least two frames, the second reference signal is a reference signal periodically sent by the second access network device in a second frame in the at least two frames, and the second reference signal and the first reference signal are simultaneously sent.

With reference to the fifth aspect or the sixth aspect, in some feasible examples, the sending unit is further configured to send a second configuration to the terminal device. The second configuration includes a mapping relationship between reference signals simultaneously sent by the first access network device and the second access network device.

With reference to the fifth aspect or the sixth aspect, in some feasible examples, the sending unit is further configured to send a third configuration to the terminal device. The third configuration includes a frame-level offset value between the first access network device and the second access network device.

With reference to the first aspect, the second aspect, the third aspect, the fourth aspect, the fifth aspect, or the sixth aspect, in some feasible examples, the positioning parameter includes at least one of the following: a quantity of cyclically shifted bits, a quantity of bits of each frame cyclically shifted relative to a previous frame, and an offset value in frequency domain. In this way, the reference signal may be processed based on the foregoing positioning parameter, so that there is a positioning-processed or an unprocessed reference signal in the first access network device and/or the second access network device, thereby facilitating identification of simultaneously sent reference signals.

With reference to the first aspect, the second aspect, the third aspect, the fourth aspect, the fifth aspect, or the sixth aspect, in some feasible examples, the quantity of cyclically shifted bits of the reference signal is greater than a timing drift of the reference signal. In this way, it can be ensured that the terminal device detects a difference between quantities of bits cyclically shifted between two adjacent reference signals.

With reference to the first aspect, the second aspect, the third aspect, the fourth aspect, the fifth aspect, or the sixth aspect, in some feasible examples, the positioning parameter of the reference signal is related to at least one of the following of the reference signal: a frame number and an index. In this way, the positioning parameter of the reference signal may be determined based on the frame number or the index of the reference signal, so that the reference signal is sent in different frames according to a specific rule.

It should be understood that specific content of the fourth aspect corresponds to content of the first aspect. For corresponding features of the fourth aspect and beneficial effects achieved, refer to descriptions of the first aspect. Specific content of the fifth aspect corresponds to content of the second aspect. For corresponding features of the fifth aspect and beneficial effects achieved, refer to descriptions of the second aspect. Specific content of the sixth aspect corresponds to content of the third aspect. For corresponding features of the sixth aspect and beneficial effects achieved, refer to descriptions of the third aspect. To avoid repetition, detailed descriptions are appropriately omitted herein.

According to a seventh aspect, an embodiment of this disclosure provides a first communication apparatus. The communication apparatus may be a terminal device, an apparatus in the terminal device, or an apparatus that can be used together with the terminal device. The communication apparatus may include a processor. The processor is configured to execute instructions in a memory or use a logic circuit, to enable the communication apparatus to perform any method according to the first aspect or the possible examples in the first aspect.

According to an eighth aspect, an embodiment of this disclosure provides a second communication apparatus. The communication apparatus may be a network device, an apparatus in the network device, or an apparatus that can be used together with the network device. The communication apparatus may include a processor. The processor is configured to execute instructions in a memory or use a logic circuit, to enable the communication apparatus to perform the communication method according to the second aspect, the third aspect, or any example of the second aspect and the third aspect.

With reference to the seventh aspect or the eighth aspect, in some feasible examples, the communication apparatus further includes one or more of a memory or a transceiver, and the transceiver is configured to receive and send data and/or signaling.

According to a ninth aspect, an embodiment of this disclosure provides a communication system. The communication system includes a terminal device and a network device. When the terminal device and the network device run in the communication system, the terminal device and the network device are configured to perform any method in the first aspect to the third aspect.

In the eighth aspect or the ninth aspect, the network device includes a first access network device, a second access network device, and a core network device.

According to a tenth aspect, an embodiment of this disclosure provides a computer-readable storage medium. The computer-readable storage medium stores instructions. When the instructions are run by a processor, the method according to any one of the foregoing aspects or the possible examples is performed.

According to an eleventh aspect, an embodiment of this disclosure provides a computer program product. The computer program product includes instructions. When the instructions are run by a processor, the method according to any one of the foregoing aspects or the possible examples is performed.

According to a twelfth aspect, this disclosure provides a chip, including a processor, configured to: invoke, from a memory, instructions stored in the memory, and run the instructions, to enable a communication apparatus in which the chip is installed to perform the method according to any one of the foregoing aspects or the possible examples.

According to a thirteenth aspect, this disclosure provides another chip, including an input interface, an output interface, and a processing circuit. The input interface, the output interface, and the circuit are connected by using an internal connection path, and the processing circuit is configured to perform the method according to any one of the foregoing aspects or the possible examples. Optionally, the chip further includes a memory. The input interface, the output interface, a processor, and the memory are connected by using an internal connection path. The processor is configured to execute code in the memory. When the code is executed, the processor is configured to perform the method according to any one of the foregoing aspects or the possible examples.

According to a fourteenth aspect, this disclosure provides a chip system, including at least one processor and a communication interface. The communication interface and the at least one processor are interconnected through a line, and the at least one processor is configured to run a computer program or instructions, to perform the method according to any one of the foregoing aspects or the possible examples.

According to a fifteenth aspect, an embodiment of this disclosure provides a fourth communication method, including the method according to any one of the foregoing aspects or the possible examples.

It should be understood that mutual reference may be made to the implementations and beneficial effects of the foregoing aspects of this disclosure.

### BRIEF DESCRIPTION OF DRAWINGS

The following describes accompanying drawings used in embodiments of this disclosure.

FIG. 1A and FIG. 1B are respectively diagrams of architectures of communication systems according to an embodiment of this disclosure;

FIG. 2A and FIG. 2B are respectively diagrams of architectures of communication systems integrating an NTN network and an integrated access and backhaul (IAB) network according to an embodiment of this disclosure;

FIG. 3 is a diagram of transmitting a positioning reference signal (PRS) by using different satellites according to an embodiment of this disclosure;

FIG. 4 is an interaction diagram of a communication method according to an embodiment of this disclosure;

FIG. 5 is another diagram of transmitting a PRS by using different satellites according to an embodiment of this disclosure;

FIG. 6 is a diagram of performing frequency offset on a reference signal according to this disclosure;

FIG. 7 is a diagram of a structure of a communication apparatus according to an embodiment of this disclosure;

FIG. 8 is a diagram of a structure of another communication apparatus according to an embodiment of this disclosure; and

FIG. 9 is a diagram of a structure of a terminal device according to an embodiment of this disclosure.

### DESCRIPTION OF EMBODIMENTS

The technical solutions provided in embodiments of this disclosure may be applied to various communication systems, for example, an NTN system, and a system in which satellite communication and a cellular network are converged. The NTN system may be a satellite communication system, and may include various non-terrestrial network systems. Compared with terrestrial communication, satellite communication has been widely used in many fields such as aviation and energy because of its wide coverage, no geographical environment limitation, and high reliability.

A satellite network device in the NTN system may be configured to communicate with one or more terminal devices. The satellite network device may include a satellite, a high-altitude platform (HAP), an uncrewed aerial vehicle, a hot air balloon, a low earth orbit satellite, a medium earth orbit satellite, a high earth orbit satellite, and the like. A satellite mentioned in this disclosure represents a set of satellites and other network devices related to satellite communication. Therefore, in this disclosure, descriptions of “satellite” and “satellite network device” are equivalent.

A cellular network system may include: a Long-Term Evolution (LTE) system, a New Radio (NR) system, a public land mobile network (PLMN) system, an LTE Advanced (LTE-A) system, a device-to-device (D2D) communication system, a machine-to-machine (M2M) communication system, an Internet of Things (IoT), a Narrowband IoT (NB-IoT), an integrated sensing and communication system, a frequency-division duplex (FDD) system, a time-division duplex (TDD) system, a wireless projection communication system, an IAB communication system, and a communication system (for example, a 6G communication system) evolved after a 5G communication system, or may be a non-3rd Generation Partnership Project (3GPP) communication system, or the like. This is not limited herein.

The terminal device in embodiments of this disclosure may be an entity that is on a user side and that is configured to receive or transmit a signal. The terminal device may be a mobile phone, a tablet computer (Pad), a computer with a wireless transceiver function, a virtual reality (VR) terminal, an augmented reality (AR) terminal, customer premises equipment (CPE), an IoT terminal, a wireless terminal in industrial control, a wireless terminal in self driving, a wireless terminal in telemedicine (remote medical), a wireless terminal in a smart grid, a wireless terminal in transportation safety, a wireless terminal in a smart city, a wireless terminal in a smart home, a terminal in integrated sensing and communication, an in-vehicle terminal, a vehicle with a vehicle-to-everything (V2X) communication capability, an intelligent connected vehicle, an uncrewed aerial vehicle with an uncrewed-aerial-vehicle-to-uncrewed-aerial-vehicle (UAV-to-UAV (U2U)) communication capability, a personal digital assistant (PDA), a wireless communication module/chip in various devices such as a smart factory or a smart grid, and the like. This is not limited herein.

The terminal device may also be referred to as UE, a terminal, an access terminal, a UE unit, a UE station, a mobile device, a mobile, a mobile station, a mobile terminal, a mobile client, a mobile unit, a remote station, a remote terminal device, a remote unit, a wireless unit, a wireless communication device, a user agent, a user apparatus, or the like. The access terminal may be a cellular phone, a cordless phone, a Session Initiation Protocol (SIP) phone, a wireless local loop (WLL) station, a PDA, a handheld device with a wireless communication function, a computing device, another processing device connected to a wireless modem, an in-vehicle device, a wearable device, a terminal device in a PLMN evolved after a 5G communication system, a terminal device in a non-public network (NPN) evolved after a 5G communication system, or the like.

A network device in the cellular network system is an entity configured to transmit or receive a signal, and is mainly configured to implement functions such as a radio physical control function, resource scheduling and radio resource management, radio access control, and mobility management, and provides a reliable radio transmission protocol, a reliable data encryption protocol, and the like. The network device may support wired access and may further support wireless access, and may be referred to as an access network device below.

Optionally, the access network device may be an access network (AN)/radio access network (RAN) device, and includes a plurality of AN/RAN nodes. The AN/RAN node may include but is not limited to: an access point (AP), an enhanced NodeB (eNB), a home base station (for example, a home evolved NodeB, or a home NodeB (HNB)), a baseband unit (BBU), a next-generation NodeB (NR NodeB, gNB), a transmission reception point (TRP), a transmission point (TP), or another access node, for example, a wireless relay node or a wireless backhaul node. Alternatively, the AN/RAN node may be an antenna panel formed by one or more nodes, or may be a network node that forms a gNB or a transmission point, for example, a BBU or a distributed unit (DU), or may be a device that undertakes a base station function in a communication system such as D2D, V2X, M2M, or U2U. Alternatively, the AN/RAN node may be a radio controller in a cloud radio access network (CRAN) scenario, or may be an open access network (open RAN, O-RAN, or ORAN), or may be a base station in a communication system evolved after a 5G communication system, for example, an xNodeB in a 6G communication system, or may be an access network device in a PLMN network evolved after a 5G communication system. This is not limited herein.

Main functions of the access network device include: radio resource management, Internet Protocol (IP) header compression and user data flow encryption, mobility management entity (MME) selection during attachment of UE, routing of user plane data to a serving gateway (SGW), paging message organization and sending, broadcast message organization and sending, measurement for a purpose of mobility or scheduling, measurement report configuration, and the like.

Optionally, the network device may include a central unit (CU), a distributed unit (DU), and the like. The CU may be further divided into a CU-control plane (CP), a CU-user plane (UP), and the like. Alternatively, the network device may be an antenna element (radio unit (RU)) or the like. Alternatively, the network device may be of an ORAN architecture, or the like. A specific deployment manner of the network device is not limited in this disclosure. For example, when the network device is of the ORAN architecture, the network device may be an access network device in the ORAN, a module in the access network device, or the like. In an ORAN system, the CU may also be referred to as an open (O)-CU, the DU may also be referred to as an O-DU, the CU-CP may also be referred to as an O-CU-CP, the CU-UP may also be referred to as an O-CU-UP, and the RU may also be referred to as an O-RU.

Optionally, the network device may further include a core network device, configured to: maintain subscription data of a mobile network, manage a network element of the mobile network, and provide functions such as session management, mobility management, policy management, and security authentication for the terminal device.

Optionally, the network device may further include a data network device, configured to provide a service for a user. Usually, a client is a terminal device, and a server is a data network device. A data network provided by the data network device may be a private network, for example, a local area network. The data network may alternatively be an external network that is not managed by an operator, for example, the Internet. The data network may alternatively be a dedicated network jointly deployed by operators, for example, a network that provides an IP multimedia subsystem (IMS) service.

Communication between a terminal device and a network device, communication between network devices, and communication between terminal devices may be performed by using a licensed spectrum, or may be performed by using an unlicensed spectrum, or may be performed by using both the licensed spectrum and the unlicensed spectrum. A spectrum resource (or a frequency domain resource) used by the terminal device and the network device is not limited in this disclosure.

In embodiments of this disclosure, the terminal device or the network device includes a hardware layer, an operating system layer running on the hardware layer, and an application layer running on the operating system layer. The hardware layer includes hardware such as a central processing unit (CPU), a memory management unit (MMU), and a memory (also referred to as a main memory). An operating system may be any one or more type of computer operating systems, for example, a LINUX operating system, a UNIX operating system, an ANDROID operating system, an IOS operating system, or a WINDOWS operating system, that implement service processing by using a process. The application layer includes applications such as a browser, an address book, word processing software, and instant messaging software. In addition, a specific structure of an execution body of a method provided in embodiments of this disclosure is not particularly limited in embodiments of this disclosure, provided that a program that records code of the method provided in embodiments of this disclosure can be run to perform communication according to the method provided in embodiments of this disclosure. For example, the execution body of the method provided in embodiments of this disclosure may be the terminal device or the network device, or a functional module that can invoke and execute the program in the terminal device or the network device.

In addition, aspects or features of this disclosure may be implemented as a method, an apparatus, or a product that uses standard programming and/or engineering technologies. The term “product” used in this disclosure covers a computer program that can be accessed from any computer-readable component, carrier, or medium. For example, a computer-readable medium may include, but is not limited to: a magnetic storage device (for example, a hard disk, a floppy disk, or a magnetic tape), an optical disc (for example, a compact disc (CD), a digital versatile disc (DVD), or the like), a smart card, and a flash memory device (for example, an erasable programmable read-only memory (EPROM), a card, a stick, or a key drive). The various storage media described in this specification may represent one or more devices and/or other machine-readable media for storing information. The term “machine-readable media” may include but is not limited to a radio channel, and various other media that can store, contain and/or carry instructions and/or data.

The following describes embodiments of this disclosure with reference to the accompanying drawings in embodiments of this disclosure.

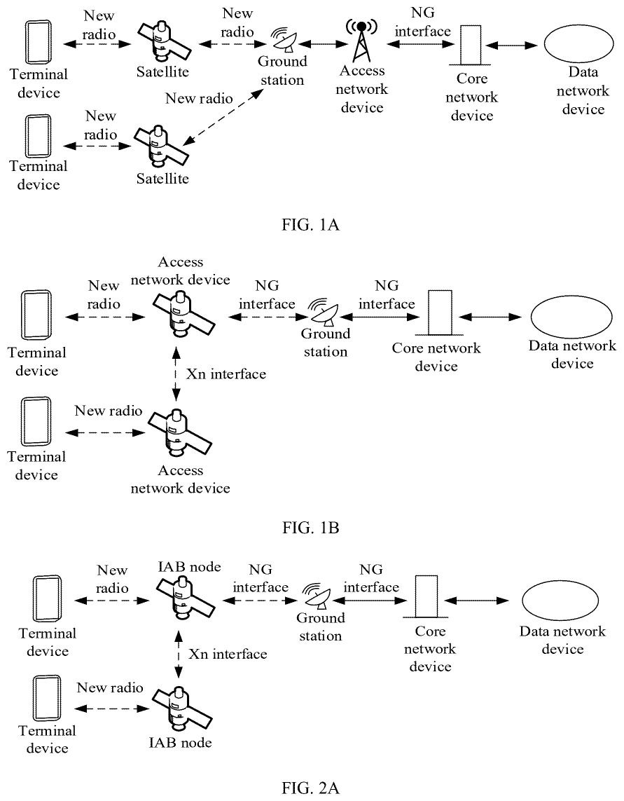

FIG. 1A and FIG. 1B are respectively diagrams of architectures of communication systems according to an embodiment of this disclosure. In FIG. 1A and FIG. 1B, an example in which an NR system is a cellular network is used for description. The communication system may be understood as a system in which satellite communication and a cellular network are converged. An air interface is a radio link between a terminal device and an access network device. An Xn interface is an interface between access network devices, and is mainly used for signaling exchange such as handover. A next generation (NG) interface is an interface between the access network device and a core network device, and is mainly configured to exchange non-access stratum (NAS) signaling of a core network and service data of a user. In a 4G communication system, the Xn interface in FIG. 1A and FIG. 1B may be set to an X2 interface, and the NG interface may be set to an S1 interface.

As shown in FIG. 1A and FIG. 1B, the communication system may include at least one terminal device and at least one network device. The terminal device may be connected to the network device in a wireless manner. The network device may include an access network device, a ground station, a core network device, a data network device, and the like. The network device may further include a satellite deployed independently, or a satellite deployed by using the access network device. For example, in FIG. 1A, the terminal device accesses a network through the air interface, and the access network device is deployed on the ground and is connected to a ground station that communicates with the satellite. In FIG. 1B, the terminal device accesses a network through the air interface, and the access network device is deployed on the satellite, and is connected to the core network device through the radio link.

The satellite is connected to the ground station through the radio link, and the ground station and the access network device are connected to the core network in a wireless or wired manner. There is a radio link between satellites. If the satellite has only a transparent transmission and forwarding function (that is, a corresponding access network device is deployed on the ground), as shown in FIG. 1A, transparent transmission and forwarding may be implemented between the satellites. If the access network device or some functions are deployed on the satellite, as shown in FIG. 1B, signaling exchange and user data transmission between the access network devices may be completed between the satellites.

The ground station is configured to forward signaling and service data between the satellite (an access network device) and the core network device. For types of the terminal device and the network device, refer to the foregoing descriptions. Details are not described herein again. In the NR system, the terminal device supports a new radio technology, and may access a satellite network through the air interface and initiate services such as a call and internet access. In addition, in the NR system, the access network device mainly provides a radio access service, schedules a radio resource for an access terminal, and provides a reliable wireless transmission protocol, a reliable data encryption protocol, and the like. The core network includes a plurality of functional units, may be divided into a control-plane functional entity and a data-plane functional entity, and may be configured to support services such as user access control, mobility management, session management, user security authentication, and charging.

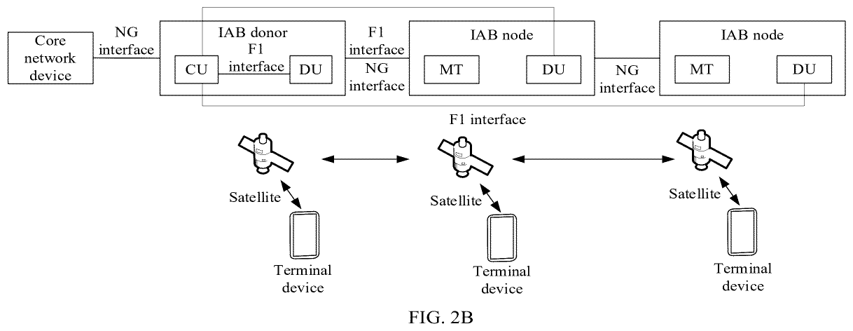

In a satellite scenario, the access network device may be an IAB node. FIG. 2A is a diagram of an architecture of a communication system integrating an NTN network and an IAB network according to an embodiment of this disclosure. In FIG. 2A, the access network device in FIG. 1B is replaced with an IAB donor. The terminal device accesses a network through the air interface. The IAB donor is deployed on the satellite, and is connected to the core network device through the radio link.

The IAB node serves as a relay node, and the relay node may also be referred to as a wireless backhaul node, a wireless backhaul device, or the like. This is not limited herein. The relay node may provide a wireless backhaul service. The wireless backhaul service is a data and/or signaling backhaul service provided through a wireless backhaul link. In one aspect, the relay node may provide a radio access service for the terminal device through an access link (AL). In another aspect, the relay node may be connected to the access network device through a one-hop or multi-hop backhaul link (BL). Therefore, the relay node may implement data and/or signaling forwarding between the terminal device and the access network device, so that coverage of the communication system is expanded.

For example, there is a radio access link between the IAB node and the terminal device (that is, a child node). That is, a link between the terminal device and the IAB node may be referred to as an access link. There is a wireless backhaul link between the IAB node and the IAB donor (that is, a parent node). That is, a link between the IAB node and the IAB donor may be referred to as a backhaul link. A link between IAB nodes may also be referred to as a backhaul link.

In an IAB network, for the IAB donor, the IAB donor may include a CU (which may be referred to as an IAB donor CU) and a DU (which may be referred to as an IAB donor DU). The IAB donor CU and the IAB donor DU are network elements divided according to a protocol stack and a function. In a possible manner, a radio resource control (RRC) layer, a service data mapping protocol (Service Data Adaptation Protocol (SDAP)) layer, and a Packet Data Convergence Protocol (PDCP) layer are deployed on the CU, and a remaining radio link control (RLC) layer, a media access control (MAC) layer, and a physical (PHY) layer are deployed on the DU.

One CU may be connected to one DU, or one CU may be connected to a plurality of DUs. In other words, the access network device may include one CU and one or more DUs. This can reduce costs and facilitate network expansion. The CU and the DU are connected through an F1 interface, which is configured to transmit configuration information of a radio bearer between the CU and the DU.

In the IAB network, for the IAB node, when the IAB node serves as a parent node, the IAB node may act as a role similar to the access network device, and provides an access service for a child node of the IAB node. For example, an uplink resource for transmitting uplink data may be allocated to the child node of the IAB node through scheduling. When the IAB node serves as a child node, for a parent node that provides a service for the IAB node, the IAB node may play a role of a terminal device, access a wireless network like the terminal device, and perform a function of the terminal device. The IAB node establishes a connection to the parent node by performing operations such as cell selection and random access, to obtain an uplink resource that is scheduled by the parent node for the IAB node and that is for transmitting the uplink data.

As an example rather than a limitation, in this embodiment of this disclosure, a role in which the IAB node serves as the terminal device is referred to as a mobile terminal (MT) side of the IAB node or an MT functional unit (which may be referred to as an IAB-MT or an IAB-UE) of the IAB node, and a role in which the IAB node serves as a device similar to the access network device is referred to as a DU side of the IAB node or a DU functional unit (which may be referred to as an IAB-DU) of the IAB node. The IAB-MT and the IAB-DU may be logical division, and functions of the IAB-MT and the IAB-DU are all implemented by the IAB node. Alternatively, the IAB-MT and the IAB-DU may be physical division, and the IAB-MT and the IAB-DU may be different physical devices in the IAB node. A function of the IAB-DU is similar to that of a DU of the gNB, and the IAB-MT has a function of UE and is configured to provide data backhaul.

For example, FIG. 2B is a diagram of an architecture of another communication system integrating an NTN network and an IAB network according to an embodiment of this disclosure. As shown in FIG. 2B, an IAB donor includes a CU (which may be referred to as an IAB donor CU) and a DU (which may be referred to as an IAB donor DU); and an IAB node includes an MT side (which may be referred to as an IAB-MT) of the IAB node and a DU side (which may be referred to as an IAB-DU) of the IAB node. The CU and the DU are connected through an F1 interface, and the CU and a core network are connected through an NG interface.

It should be noted that FIG. 2A and FIG. 2B are described by using the IAB network as an example. Content in FIG. 2A and FIG. 2B is also applicable to a relay network outside the IAB network. In this case, the IAB node may be replaced with a relay node, and the IAB donor may be replaced with a host node. An MT side of the relay node performs a function of a terminal device role of the relay node, and a DU side of the relay node performs a function of an access network device role of the relay node. For details, refer to the content of the IAB network. Details are not described herein again.

In the network architectures shown in FIG. 1A, FIG. 1B, FIG. 2A, and FIG. 2B, although the network device and the terminal device are shown, the application scenario may not be limited to the network device and the terminal device, for example, may further include a device configured to carry a virtualized network function. These are obvious to persons skilled in the art, and details are not described herein again.

In addition, quantities and types of network devices and terminal devices included in the network architectures shown in FIG. 1A, FIG. 1B, FIG. 2A, and FIG. 2B are merely examples, and embodiments of this disclosure are not limited thereto. For example, more or fewer terminal devices that communicate with the network device may be included. For another example, more or fewer terminal devices that communicate with the network device may be included. For conciseness of description, this is not described one by one in the accompanying drawings.

A positioning method for the terminal device in this disclosure may be based on an OTDOA technology, or may be measured by using advanced forward link trilateration (AFLT), radio access network (WLAN) positioning (also referred to as WI-FI positioning), an angle of departure (AOD), an angle of arrival (AOA), a multi-cellular signal propagation round-trip time (multi-RTT), or the like. In these technologies, a location of the terminal device may be measured by using three or more network devices at fixed locations.

The following uses the OTDOA technology as an example. The technology may also be referred to as DL-TDOA. In this case, the terminal device mainly receives and measures RSTDs of reference signals sent by several cells, and reports a measurement result to a network side or a positioning server. The network side or the positioning server positions the terminal device by using a known location of a network device and a plurality of RSTDs.

In this embodiment of this disclosure, the reference signal may be a pilot signal, and is a known signal provided by a transmit end for a receive end for channel estimation or channel sounding. The reference signal may include one or more of a PRS, a cell-specific reference signal (CRS), a sounding reference signal (SRS), a channel state information reference signal (CSI-RS), a demodulation reference signal (DMRS), a phase tracking reference signal (PT-RS), and the like.

The CRS may be used by the terminal device to perform channel assessment on a downlink physical channel of the network device, and may be used to send a channel quality indicator (CQI) or reference signal received power (RSRP), or may be used by the terminal device to obtain CSI, and serve as a basis for selecting a cell to be camped on by the terminal device. The SRS is used for uplink channel measurement, time-frequency synchronization, beam management, and the like. The CSI-RS is used for downlink channel measurement, obtaining downlink channel state information, beam management, radio resource management (RRM) measurement/radio link monitoring (RLM) measurement and refined time-frequency tracking, mobility management, rate matching, and the like. The DMRS is used for channel estimation to demodulate a corresponding physical channel, for example, a physical downlink shared channel (PDSCH), a physical uplink shared channel (PUSCH), a physical downlink control channel (PDCCH), and a physical uplink control channel (PUCCH). The PT-RS is used for phase noise tracking and compensation. Reference signal downlink control information (RS DCI) is a reference signal including downlink control information (DCI).

In the 3GPP Technical Specification (TS) 38.214, a PRS resource appears periodically in time domain. Periodicity may be configured as 2^{μ}{4, 5, 8, 10, 16, 20, 32, 40, 64, 80, 160, 320, 640, 1280, 2560, 5120, 10240} slots, where μ=0,1,2,3 corresponds to subcarrier configurations at 15, 30, 60, and 120 kilohertz (kHz), respectively. Compared with other reference signals, the PRS enables the terminal device to measure more signals, thereby improving positioning performance.

The access network device may configure a PRS on one or more PRS resources of a channel, PRS transmission depends on a quantity of configured ports, and the PRS resource may span resource elements of a plurality of physical resource blocks (PRBs) in one or more orthogonal frequency-division multiplexing (OFDM) symbols of a slot. For example, a PRS resource may span one symbol of a slot and includes a port for transmission. The PRS transmission may be mapped to contiguous OFDM symbols of the slot, or mapped to interleaved OFDM symbols of the slot. The PRS transmission may support frequency hopping within a PRB of a channel.

Due to differences in locations of different access network devices, transmission delays of reference signals sent between the different access network devices are different. Especially in an NTN network, a distance between satellites and a distance between a satellite and a terminal device are large, and there is a high transmission delay in reference signal transmission between the satellite and the terminal device. In addition, there is a high transmission delay between reference signals received by the terminal device from different satellites, and the transmission delay may exceed half a frame length. Therefore, two reference signals used for RSTD measurement are positioned in incorrect frames, leading to a problem of frame-level timing ambiguity. As a result, an error occurs in positioning of the terminal device.

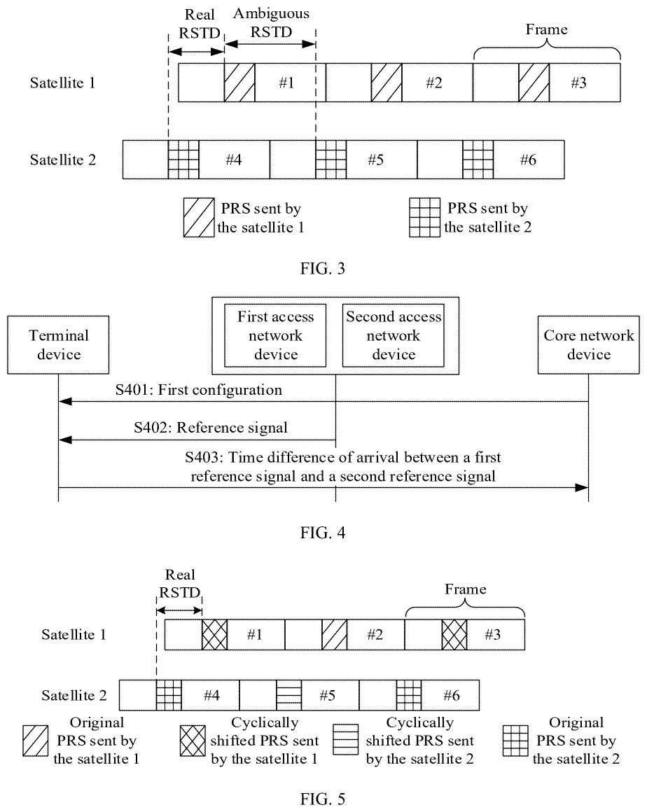

For example, FIG. 3 is a diagram of transmitting a PRS by using different satellites according to an embodiment of this disclosure. In FIG. 3, a satellite 1 and a satellite 2 are used as an example for description. As shown in FIG. 3, the satellite 1 may periodically send a PRS to a terminal device by using a frame #1, a frame #2, and a frame #3, and the satellite 2 may periodically send a PRS to the terminal device by using a frame #4, a frame #5, and a frame #6. After receiving PRSs from the satellite 1 and the satellite 2, the terminal device may take, as an RSTD, a difference between a time at which a PRS is received in the frame #1 of the satellite 1 and a time at which a PRS is received in the frame #5 of the satellite 2. However, an actual RSTD is a difference between a time at which the terminal device receives the PRS in the frame #1 of the satellite 1 and a time at which the terminal device receives a PRS in the frame #4 of the satellite 2. Due to incorrect time positioning of two reference signals used by the terminal device to measure the RSTD in a frame, an error occurs in positioning of the terminal device.

Based on this, this disclosure provides a communication method and a related apparatus. In this way, a problem of frame-level timing ambiguity can be resolved, accuracy of determining a time difference of arrival between reference signals simultaneously sent by different access network devices is improved, thereby helping improve positioning accuracy of a terminal device.

The communication method provided in embodiments of this disclosure may be applied to various communication scenarios, for example, one or more of enhanced mobile broadband (eMBB), ultra-reliable low-latency communication (URLLC), machine type communication (MTC), massive machine type communication (mMTC), enhanced machine type communication (eMTC), an IoT, an NB-IOT, CPE, AR, VR, D2D, and V2X.

FIG. 4 is an interaction diagram of a communication method according to an embodiment of this disclosure. A terminal device in this embodiment may be the terminal device in the foregoing communication system. In this embodiment, a function performed by the terminal device may be performed by an apparatus (for example, a chip, a chip system, or a circuit) in the terminal device, or may be an apparatus that can be used together with the terminal device. A network device in this embodiment may be the network device in the foregoing communication system. Optionally, a first access network device is the satellite 1, and a second access network device is the satellite 2. The satellite 1 may be a primary satellite, that is, a serving satellite, and the satellite 2 may be an assisting satellite. In this embodiment, a function performed by the network device may be performed by an apparatus (for example, a chip, a chip system, or a circuit) in the network device, or may be an apparatus that can be used together with the network device.

The communication method includes but is not limited to the following step S401 to step S403. Step S402 is shown in FIG. 4. The first access network device and the second access network device simultaneously send reference signals to the terminal device. However, due to differences in transmission delays of different access network devices, the terminal device should receive the reference signals sent by the first access network device and the second access network device at different times. A first reference signal may be received before a second reference signal, or the first reference signal may be received after the second reference signal.

S401: A core network device sends a first configuration to the terminal device. Correspondingly, the terminal device receives the first configuration from the core network device.

FIG. 4 is described by using an example in which the core network device sends the first configuration to the terminal device. Actually, another device may be further included. For example, in another example, the first access network device or a positioning server sends the first configuration to the terminal device. Correspondingly, the terminal device receives the first configuration from the core network device or the positioning server.

The first configuration may be indicated by using signaling such as DCI, RRC, or a MAC control element (CE). This is not limited herein.

The first configuration includes a positioning parameter of a reference signal periodically sent by at least one of the first access network device and the second access network device. The positioning parameter is used to determine a location of the reference signal periodically sent by the access network device, for example, a frame number, an offset value in time domain, or an offset value in frequency domain. For the reference signal, refer to the foregoing descriptions. The reference signal includes one or more of a PRS, a CRS, an SRS, a CSI-RS, a DMRS, a PT-RS, and the like. Details are not described herein again. Optionally, the reference signal is a PRS. Further, the reference signal is a PRS and another reference signal. For example, if the other reference signal is a CSI-RS, a measurement mode may be configured to be CSI-RS measurement, so that the terminal device receives a time difference of a corresponding signal.

The positioning parameter in the first configuration is not limited in this disclosure. Optionally, the first configuration may include a quantity of cyclically shifted bits of a reference signal periodically sent by at least one of a first access network device and a second access network device. In other words, both the first access network device and the second access network device may perform periodic cyclic shift on the reference signal, or the first access network device performs periodic cyclic shift on the reference signal while the second access network device does not perform periodic cyclic shift on the reference signal, or the second access network device performs periodic cyclic shift on the reference signal while the first access network device does not perform periodic cyclic shift on the reference signal. In this way, both the first access network device and the second access network device perform periodic cyclic shift on the reference signal, or one of the first access network device and the second access network device performs periodic cyclic shift on the reference signal, while the other maintains an original sending manner, so that reference signals sent by different access network devices can be distinguished based on whether periodic cyclic shift is performed on the reference signal in a frame.

Optionally, the first configuration may include a quantity of bits of each frame cyclically shifted relative to a previous frame of a reference signal periodically sent by at least one of the first access network device and the second access network device. In other words, both the first access network device and the second access network device may perform cyclic shift on a reference signal of a current frame based on a reference signal of a previous frame, or the first access network device performs cyclic shift on the reference signal of the current frame based on the reference signal of the previous frame while the second access network device does not perform cyclic shift on the reference signal of the current frame based on the reference signal of the previous frame, or the second access network device performs cyclic shift on the reference signal of the current frame based on the reference signal of the previous frame while the first access network device does not perform cyclic shift on the reference signal of the current frame based on the reference signal of the previous frame. In this way, both the first access network device and the second access network device perform cyclic shift on the reference signal of the current frame based on the reference signal of the previous frame, or one of the first access network device and the second access network device performs cyclic shift on the reference signal of the current frame based on the reference signal of the previous frame, while the other maintains an original sending manner, so that reference signals sent by different access network devices are distinguished by using different cyclic shifts of reference signals in previous and next frames.

Optionally, the positioning parameter of the reference signal is related to a frame number and/or an index of the reference signal. In this way, the positioning parameter of the reference signal may be determined based on the frame number or the index of the reference signal, so that the reference signal is sent in different frames according to a specific rule.

The following uses the quantity of cyclically shifted bits of the reference signal as an example. In an example, the quantity of cyclically shifted bits of the reference signal may be equal to the frame number of the reference signal modulo x. For example, if x=2, because 1 mod 2=1, the reference signal transmitted in a frame #1 is cyclically shifted by one bit relative to an original reference signal. However, in a frame #2, because 2 mod 2=0, the reference signal transmitted in the frame #2 is cyclically shifted by 0 bits relative to the original reference signal, and therefore no cyclic shift is required. By analogy, reference signals transmitted in a frame #3, a frame #5, and the like are cyclically shifted by one bit relative to the original reference signal, and reference signals transmitted in a frame #4, a frame #6, and the like do not need to be cyclically shifted.

An example in which a satellite 1 is the first access network device, a satellite 2 is the second access network device, and the reference signal is a PRS is used. FIG. 5 is another diagram of transmitting a PRS by using different satellites according to an embodiment of this disclosure. As shown in FIG. 5, cyclic shift is performed on the frame #1 and the frame #2 in the satellite 1 and the frame #5 in the satellite 2, but no cyclic shift is performed on the frame #2 in the satellite 1 and the frame #4 and the frame #6 in the satellite 2.

In the foregoing example, the frame number is used for description. The positioning parameter (for example, the quantity of cyclically shifted bits) of the reference signal may be obtained based on a value corresponding to the index modulo x, or the positioning parameter of the reference signal may be generated based on a function corresponding to the index.

The quantity of cyclically shifted bits is not limited in this disclosure. Quantities of periodically cyclically shifted bits of a same access network device may be the same, and quantities of periodically cyclically shifted bits of different access network devices may be the same or different. If a quantity of cyclically shifted bits of a reference signal sent by the first access network device is y, and a quantity of cyclically shifted bits of a reference signal sent by the second access network device is y′, y=y′, or y≠y′, where y and y′ should be positive integers. For example, when a PRS sent by the first access network device and a PRS sent by the second access network device are a same signal, y=y′; or when the PRS sent by the first access network device and the PRS sent by the second access network device are different signals, y≠y′.

A same access network device may cyclically shift a same quantity of bits on the reference signal of the current frame based on the reference signal of the previous frame, while different access network devices may cyclically shift a same quantity of bits or different quantities of bits on the reference signal of the current frame based on the reference signal of the previous frame. In addition, a quantity of bits cyclically shifted by the access network device on the reference signal of the current frame based on the reference signal of the previous frame may be the same as or different from a quantity of bits periodically cyclically shifted by the access network device. The first access network device is used as an example. If the first access network device sequentially sends reference signals by using the frame #1, the frame #2, and the frame 3, a quantity of bits of the frame #2 cyclically shifted relative to the frame #1 is c, a quantity of bits of the frame #3 cyclically shifted relative to the frame #2 is c, and the like. The quantity c of cyclically shifted bits may be the same as or different from the quantity y of cyclically shifted bits.

A quantity of cyclically shifted reference signals may be the same as or different from a quantity of non-cyclically shifted reference signals. For example, if the access network device sends reference signals in three frames, one bit is shifted for both the frame #1 and the frame #3, and the frame #2 is not shifted, the quantity of cyclically shifted reference signals is greater than the quantity of non-cyclically shifted reference signals. If the access network device sends reference signals in four frames, one bit is shifted for both the frame #1 and the frame #3, and the frame #2 and the frame #4 are not shifted, the quantity of cyclically shifted reference signals is equal to the quantity of non-cyclically shifted reference signals.

Optionally, a quantity of cyclically shifted bits of the reference signal is greater than a timing drift of the reference signal. In this way, it can be ensured that the terminal device detects a difference between quantities of bits cyclically shifted between two adjacent reference signals.

Optionally, the first configuration may include an offset value, in frequency domain, of a reference signal periodically sent by at least one of the first access network device and the second access network device. In other words, both the first access network device and the second access network device may perform periodic offset on the reference signal in frequency domain, or the first access network device performs periodic offset on the reference signal in frequency domain while the second access network device does not perform periodic offset on the reference signal in frequency domain, or the second access network device performs periodic offset on the reference signal in frequency domain while the first access network device does not perform periodic offset on the reference signal in frequency domain. In this way, both the first access network device and the second access network device perform periodic offset on the reference signal in frequency domain, or one of reference signals performs periodic offset on the reference signal in frequency domain, and the other remains an original sending manner, so that reference signals sent by different access network devices are distinguished based on frequency offset of the reference signal in frames.

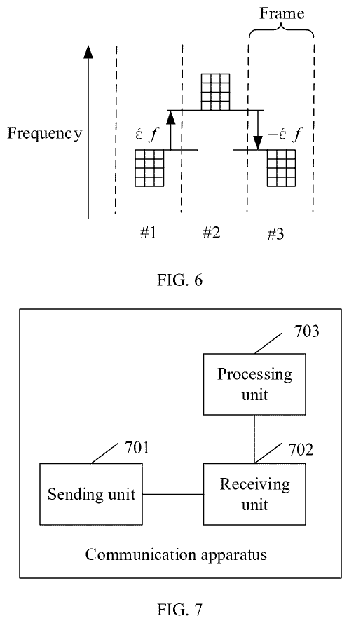

A frequency offset manner is also not limited in this disclosure. The offset value of the reference signal in frequency domain may be related to the frame number and/or the index of the reference signal. For example, different frequency offsets may be used for reference signals in different frames based on a frame number or a corresponding value. Alternatively, FIG. 6 is a diagram of performing frequency offset on a reference signal according to this disclosure. As shown in FIG. 6, a frequency offset of the frame #2 relative to the frame #1 is Δƒ, and a frequency offset of the frame #3 relative to the frame #2 is −Δƒ. If frequency offset is not performed on the frame #1, frequency offset is not performed on the frame #3 either.

Optionally, if the first access network device sends the reference signal based on the positioning parameter, a period of the reference signal is N times a source period, where N is an integer greater than 1. The source period is a period before the first access network device sends the reference signal based on the positioning parameter, and may be understood as a period of a source reference signal, that is, a period in which the reference signal is sent without using the communication method provided in this disclosure.

For example, if the positioning parameter is the offset value in frequency domain, a period of a reference signal on which periodic offset is performed in frequency domain is N times the source period. For example, if the positioning parameter is a quantity of periodically cyclically shifted bits, a period of a reference signal sent based on the positioning parameter may be a time length of two frames as shown in FIG. 5, and a source period may be a time length of a single frame as shown in FIG. 3, that is, N is 2. In this way, after the reference signal is processed based on the positioning parameter, positioning processing is performed on some of the reference signals sent by the access network device, so that positioning can be performed based on the processed reference signal or an unprocessed reference signal, thereby helping improve accuracy of frame-level positioning.

The foregoing solution is described by using the first access network device as an example. Actually, a period after the second access network device or another access network device sends the reference signal based on the positioning parameter may also be N times a period in which the access network device sends a source reference signal.

Before the terminal device receives the first configuration, the terminal device may obtain a second configuration. The second configuration includes a mapping relationship between reference signals simultaneously sent by the first access network device and the second access network device, so that the reference signals simultaneously sent by the first access network device and the second access network device may be determined by using the mapping relationship, and a time difference of arrival between the two reference signals is determined.

The mapping relationship in the second configuration may be directly indicated or indirectly indicated. When one of the first access network device and the second access network device performs periodic cyclic shift, or performs cyclic shift on a reference signal of a current frame based on a reference signal of a previous frame, or performs processing such as periodic offset in frequency domain, but the other access network device does not perform processing, the mapping relationship in the second configuration may be directly indicated. For example, a reference signal corresponding to a frame number is a reference signal simultaneously sent by different access network devices. For example, a reference signal sent by the first access network device in the frame #1 corresponds to a reference signal sent by the second access network device in the frame #5, and the like.

The mapping relationship in the second configuration may be indirectly indicated by using a processing feature between reference signals. The processing feature may correspond to a positioning parameter such as a periodic cyclic shift, a cyclic shift for a reference signal of a current frame based on a reference signal of a previous frame, or a periodic frequency-domain offset. For example, the second configuration indicates that a cyclically shifted reference signal of the first access network device corresponds to a non-cyclically shifted reference signal of the second access network device; or the second configuration indicates that a cyclically shifted reference signal of the first access network device corresponds to a cyclically shifted reference signal of the second access network device; or the second configuration indicates that a reference signal of the first access network device with an added spectral offset corresponds to a reference signal of the second access network device without spectral offset.

The second configuration may be configured by a network device such as the first access network device or the core network device, or a positioning server, or may be predefined or pre-configured, or the like. This is not limited herein. Predefined content is usually defined in a standard, does not need to be configured by another device, and is information recorded/written in advance in hardware and/or software of the terminal device, or may be understood as information that cannot be changed by the network device or another terminal device. Pre-configured content is usually information recorded/written in advance in hardware and/or software of the terminal device, is determined by a factory device vendor, and may be changed by using software or hardware. The configuration may be classified into a network configuration and a terminal configuration. If the configuration is the network configuration, the configuration may be changed by using a system information block (SIB) or RRC signaling. If the configuration is the terminal configuration, the configuration may be changed based on PC5-RRC signaling. Optionally, the method further includes: the terminal device receives the second configuration from the first access network device or the core network device. Correspondingly, the first access network device or the core network device sends the second configuration to the terminal device.

It may be understood that the positioning parameter of a reference signal of at least one of the first access network device and the second access network device is determined by using the first configuration, and then a mapping relationship of reference signals simultaneously sent by the first access network device and the second access network device may be determined by using the second configuration, thereby improving accuracy of determining reference signals simultaneously sent by different access network devices.

When the reference signal is a PRS, the second configuration may be a PRS configuration. The PRS configuration may include a quantity of subframes (for example, N_{PRS}) contiguously occupied in the PRS, a period (for example, T_{PRS}) of the PRS, a silent sequence, a frequency hopping sequence, a PRS identifier, a PRS bandwidth, and the like. In some feasible examples, the PRS configuration may further include auxiliary data, for example, a slot offset value (SlotNumberOffset), and a subframe offset value (SubframeOffset). SlotNumberOffset is a difference in quantities of slots transmitted between a current cell and a neighboring cell, and SubframeOffset is a difference in quantities of subframes transmitted between the current cell and the neighboring cell. The auxiliary data may further include a center channel frequency of each cell, a cell global identifier, a PRS feature associated with a directional PRS, and/or another cell-related parameter applicable to OTDOA or another positioning method. In this way, the access network device may send the PRS based on the PRS configuration of the access network device, and the terminal device may determine the configuration parameter of the PRS from the access network device based on the PRS configuration of the access network device, thereby improving accuracy of determining the time difference of arrival.

S402: The first access network device and the second access network device separately send a reference signal to the terminal device in at least two frames at the same time. Correspondingly, the terminal device receives the reference signal from the first access network device in the at least two frames, and the terminal device receives the reference signal from the second access network device in the at least two frames.

For example, the terminal device receives the reference signal of the first access network device in the frame #1, the frame #2, and the frame #3, and the terminal device receives the reference signal of the second access network device in the frame #4, the frame #5, and the frame #6.

In this embodiment of this disclosure, the first reference signal is a reference signal sent by the first access network device in a first frame in the at least two frames, the second reference signal is a reference signal sent by the second access network device in a second frame in the at least two frames, and the first reference signal and the second reference signal are simultaneously sent. The first frame and the second frame are not limited in this disclosure. If the first reference signal is any one of at least two reference signals sent by the first access network device, the second reference signal is a reference signal corresponding to the first reference signal in at least two reference signals sent by the second access network device. If the second reference signal is any one of the at least two reference signals sent by the second access network device, the first reference signal is a reference signal corresponding to the second reference signal in the at least two reference signals sent by the first access network device. A correspondence herein may be understood as that sending times are the same. A quantity of reference signals sent by a first network device and a quantity of reference signals sent by a second network device to the terminal device should be the same, and types of the reference signals may be the same or different.

An example in which a satellite 1 is the first access network device, a satellite 2 is the second access network device, and the reference signal is a PRS is used. As shown in FIG. 5, it is assumed that the second configuration indicates that a mapping relationship between PRSs simultaneously sent by the satellite 1 and the satellite 2 is that a cyclically shifted PRS of the satellite 1 corresponds to a non-cyclically shifted PRS of the satellite 2, and the cyclic shift for the satellite 1 and the satellite 2 is obtained by performing a modulo operation on a frame number of the PRS and 2. In this case, the first reference signal is a PRS sent by the satellite 1 in the frame #1, and the second reference signal is a PRS sent in the frame #4. That is, the PRS sent in the frame #1 and the PRS sent in the frame #4 are sent at the same time. By analogy, a reference signal sent in the frame #2 and a PRS sent in the frame #5 are sent simultaneously, and a PRS sent in the frame #3 and a PRS sent in the frame #6 are sent simultaneously.

S403: The terminal device sends a time difference of arrival between the first reference signal and the second reference signal to the core network device. Correspondingly, the core network device receives the time difference of arrival between the first reference signal and the second reference signal from the terminal device.

Optionally, before step S403, the method may further include: the terminal device determines the time difference of arrival between the first reference signal and the second reference signal based on receiving time of the first reference signal and the second reference signal and the second configuration. For the second configuration, refer to the descriptions of step S401. Details are not described herein again.

In the communication method shown in FIG. 4, after receiving the first configuration, the terminal device may determine a reference signal that is in the reference signal sent by the first access network device and the reference signal sent by the second access network device and that is processed or not processed by using the positioning parameter in the first configuration, thereby further determining the first reference signal and the second reference signal that are simultaneously sent and frames in which the two reference signals are located, and measuring and reporting the time difference of arrival between the first reference signal and the second reference signal to a network side. In this way, a problem of frame-level timing ambiguity can be resolved, accuracy of determining a time difference of arrival between reference signals simultaneously sent by different access network devices is improved, thereby helping improve positioning accuracy of a terminal device.

It should be noted that, in FIG. 4, the first access network device and the second access network device are used as an example for description. Actually, in the positioning method for the terminal device, one of the first access network device and the second access network device and another access network device, or two other access network devices may send reference signals to the terminal device, so that the terminal device reports a time difference of arrival between reference signals simultaneously sent by different access network devices. In addition, to improve positioning accuracy of the terminal device, when the first access network device and the second access network device are separately used for positioning, the first access network device, the second access network device, and the terminal device need to repeat step S402 and step S403 a plurality of times (for example, at least twice).

Optionally, the method may further include: the first access network device or the core network device sends a third configuration to the terminal device. Correspondingly, the terminal device receives the third configuration from the first access network device or the core network device. In some other feasible examples, the third configuration may alternatively be from the positioning server or the like.

The third configuration includes a frame-level offset value between the first access network device and the second access network device. The third configuration may be separately transmitted, or may be transmitted together with the second configuration. For example, the third configuration is carried in auxiliary data of the second configuration.

The frame-level offset value is not limited in this disclosure, and the frame-level offset value may be an integer not equal to 0. Optionally, the frame-level offset value is an integer greater than 0. For example, the frame-level offset value is denoted as FrameOffset, and the third configuration may include FrameOffset INTEGER (0, max_value) OPTIONAL, where a value of max_value is not limited.

It may be understood that after the frame-level offset value between the first access network device and the second access network device is indicated, the terminal device may directly determine a relationship between frames in which the first access network device and the second access network device simultaneously send reference signals. For example, FrameOffset=3. If the first reference signal is a PRS in the frame #1, the second reference signal is a PRS in the frame #4. In this way, frames in which the first reference signal and the second reference signal are located may be determined by using the frame-level offset value, thereby improving accuracy of determining reference signals simultaneously sent by different access network devices, and helping improve positioning accuracy of the terminal device.

SlotNumberOffset and SubframeOffset are not limited in this disclosure. Optionally, definitions of SlotNumberOffset and SubframeOffset are modified with reference to a standard (for example, TS 37.355), so that SlotNumberOffset and SubframeOffset directly indicate a corresponding frame instead of a nearest sequence frame. In this way, accuracy of reference signals simultaneously sent by different access network devices can be further improved.

The foregoing describes in detail methods in embodiments of this disclosure. The following provides the apparatuses in embodiments of this disclosure.

FIG. 7 is a diagram of a structure of a communication apparatus according to an embodiment of this disclosure. The communication apparatus may include a sending unit 701, a receiving unit 702, and a processing unit 703. The sending unit 701 may be an apparatus having a signal input (receiving) function, and the receiving unit 702 may be an apparatus having a signal output (sending) function. The sending unit 701 and the receiving unit 702 are configured to perform signal transmission with another device or another component in the device.

The processing unit 703 may be an apparatus having a processing function, and may include one or more processors. The processor may be a general-purpose processor, a dedicated processor, or the like. The processor may be a baseband processor or a central processing unit. The baseband processor may be configured to process a communication protocol and communication data. The central processing unit may be configured to: control the apparatus (for example, a donor node, a relay node, or a chip), execute a software program, and process data of the software program.

The communication apparatus may include a terminal device, a first access network device, a second access network device, and a core network device. When the communication apparatus is a terminal device, the communication apparatus includes: the receiving unit 702, configured to: receive a first configuration from the first access network device or the core network device, where the first configuration includes a positioning parameter of a reference signal periodically sent by at least one of the first access network device and a second access network device; receive a first reference signal from the first access network device, where the first reference signal is a reference signal sent by the first access network device in a first frame in at least two frames; and receive a second reference signal from the second access network device, where the second reference signal is a reference signal sent by the second access network device in a second frame in the at least two frames, and the second reference signal and the first reference signal are simultaneously sent; and the sending unit 701, configured to send a time difference of arrival between the first reference signal and the second reference signal to the core network device.

Optionally, the processing unit 703 is configured to determine the time difference of arrival based on receiving time of the first reference signal and the second reference signal and a second configuration. The second configuration includes a mapping relationship between reference signals simultaneously sent by the first access network device and the second access network device, and the second configuration is predefined or pre-configured, or is from the first access network device or the core network device.

Optionally, the receiving unit 702 is further configured to receive a third configuration from the first access network device or the core network device. The third configuration includes a frame-level offset value between the first access network device and the second access network device.

When the communication apparatus is a first access network device, the communication apparatus includes: the sending unit 701, configured to: send the first configuration to the terminal device, where the first configuration includes a positioning parameter of a reference signal periodically sent by at least one of a first access network device and a second access network device; and separately send a reference signal to the terminal device in at least two frames, where the reference signal includes a first reference signal sent in a first frame in the at least two frames.

Optionally, if the first access network device sends the reference signal based on the positioning parameter, a period of the reference signal is N times a source period. N is an integer greater than 1, and the source period is a period before the first access network device sends the reference signal based on the positioning parameter.

Optionally, the sending unit 701 is further configured to send a second configuration to the terminal device. The second configuration includes a mapping relationship between reference signals simultaneously sent by the first access network device and the second access network device.

Optionally, the sending unit 701 is further configured to send a third configuration to the terminal device. The third configuration includes a frame-level offset value between the first access network device and the second access network device.

When the communication apparatus is a core network device, the communication apparatus includes: the sending unit 701, configured to: send the first configuration to the terminal device, where the first configuration includes a positioning parameter of a reference signal periodically sent by at least one of a first access network device and a second access network device; and the receiving unit 702, configured to receive a time difference of arrival between a first reference signal and a second reference signal from the terminal device. The first reference signal is a reference signal periodically sent by the first access network device in a first frame in at least two frames, the second reference signal is a reference signal periodically sent by the second access network device in a second frame in the at least two frames, and the second reference signal and the first reference signal are simultaneously sent.

Optionally, the sending unit 701 is further configured to send a second configuration to the terminal device. The second configuration includes a mapping relationship between reference signals simultaneously sent by the first access network device and the second access network device.

Optionally, the sending unit 701 is further configured to send a third configuration to the terminal device. The third configuration includes a frame-level offset value between the first access network device and the second access network device.

For implementations of the sending unit 701, the receiving unit 702, and the processing unit 703, refer to related descriptions in the method embodiment shown in FIG. 4. Details are not described herein. In addition, the communication apparatus may further include a limitation.

Optionally, the positioning parameter includes at least one of the following: a quantity of cyclically shifted bits, a quantity of bits of each frame cyclically shifted relative to a previous frame, and an offset value in frequency domain.

Optionally, a quantity of cyclically shifted bits of the reference signal is greater than a timing drift of the reference signal.

Optionally, the positioning parameter of the reference signal is related to at least one of the following of the reference signal: a frame number and an index.

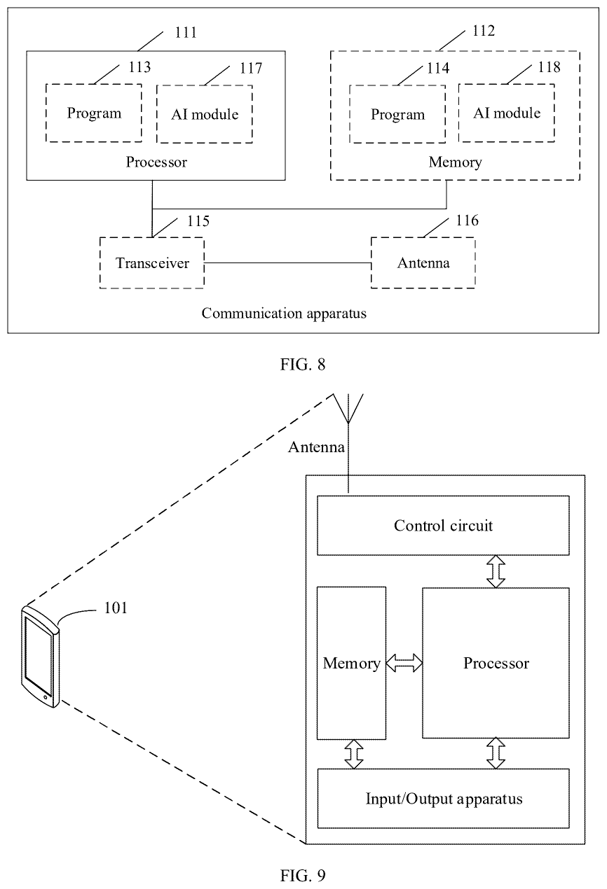

FIG. 8 is a diagram of a structure of another communication apparatus according to an embodiment of this disclosure. It may be understood that the communication apparatus includes forms such as a module, a unit, an element, a circuit, or an interface, to be properly configured together to perform the solutions. The communication apparatus may be a RAN node, a terminal, a core network device, or another network device, or may be a component (for example, a chip) in these devices, to implement the methods described in the method embodiments.

As shown in FIG. 8, the communication apparatus may include one or more processors 111. The processor 111 may also be referred to as a processing unit, and may implement a specific control function. The processor 111 may be a general-purpose processor, a dedicated processor, or the like. For example, the processor 111 may be a baseband processor or a central processing unit. The baseband processor may be configured to process a communication protocol and communication data. The central processing unit may be configured to: control a communication apparatus (for example, a base station, a baseband chip, a terminal, a terminal chip, a DU, or a CU), execute a software program, and process data of the software program.

In an optional design, the processor 111 may include a program 113 (which may also be referred to as code or instructions sometimes), and the program 113 may be run on the processor 111, so that the communication apparatus performs the methods described in the method embodiments.

In another optional design, the processor 111 may include a transceiver unit configured to implement a receiving function and a sending function. For example, the transceiver unit may be a transceiver circuit, an interface, an interface circuit, or a communication interface. The transceiver circuit, the interface, or the interface circuit configured to implement the receiving and sending functions may be separated, or may be integrated together. The transceiver circuit, the interface, or the interface circuit may be configured to read and write code/data. Alternatively, the transceiver circuit, the interface, or the interface circuit may be configured to transmit or transfer a signal.

In still another possible design, the communication apparatus may include a circuit, and the circuit may implement a sending, receiving, or communication function in the foregoing method embodiments.

Optionally, the communication apparatus may include one or more memories 112, and the memory 112 stores a program 114 (which may also be referred to as code or instructions sometimes). The program 114 may be run on the processor 111, so that the communication apparatus performs the methods described in the foregoing method embodiments.

Optionally, the processor 111 may include an artificial intelligence (AI) module 117, and/or the memory 112 may include an AI module 118. The AI module is configured to implement an AI-related function. The AI module may be implemented by using software, hardware, or a combination of software and hardware. For example, the AI module may include a RAN intelligent controller (RIC) module. For example, the AI module may be a near-real-time RIC or a non-real-time RIC.

Optionally, the processor 111 and/or the memory 112 may further store data. The processor and the memory may be separately disposed, or may be integrated together. For example, the correspondence described in the foregoing method embodiments may be stored in the memory or stored in the processor.

Optionally, the communication apparatus may further include a transceiver 115 and/or an antenna 116. The processor 111 may also be referred to as a processing unit sometimes, and controls the communication apparatus (for example, a RAN node or a terminal). The transceiver 115 may sometimes be referred to as a transceiver unit, a transceiver machine, a transceiver circuit, a transceiver device, or the like, and is configured to implement sending and receiving functions of the communication apparatus by using the antenna 116.

Optionally, the communication apparatus may be configured to perform any method described in FIG. 4 in embodiments of this disclosure.

In an embodiment, the communication apparatus may be a terminal device, or may be an apparatus in the terminal device, or may be an apparatus that can be used together with the terminal device. When the computer program instructions stored in the memory 112 are executed, the processor 111 is configured to perform an operation performed by the processing unit 703 in the foregoing embodiment. The transceiver 115 is configured to perform operations performed by the sending unit 701 and the receiving unit 702 in the foregoing embodiment. The transceiver 115 is further configured to send information to another communication apparatus other than the communication apparatus. The terminal device or the apparatus in the terminal device may be further configured to perform any method performed by the terminal device in the method embodiment in FIG. 4. Details are not described herein again.

In an embodiment, the communication apparatus may be a network device, or may be an apparatus in the network device, or may be an apparatus that can be used together with the network device. When the computer program instructions stored in the memory 112 are executed, the processor 111 is configured to control the transceiver 115 to perform the operations performed by the sending unit 701 and the receiving unit 702 in the foregoing embodiment. The transceiver 115 is further configured to receive information from another communication apparatus other than the communication apparatus. The network device or the apparatus in the network device may be further configured to perform any method performed by the network device in the method embodiment in FIG. 4. Details are not described herein again.

The processor and the transceiver described in this disclosure may be implemented in an integrated circuit (IC), an analog IC, a radio frequency integrated circuit (RFIC), a hybrid signal IC, an application-specific integrated circuit (ASIC), a printed circuit board (PCB), an electronic device, and the like. The processor and the transceiver may be manufactured by using various IC technologies, for example, a complementary metal-oxide-semiconductor (CMOS), an N-type metal-oxide-semiconductor (NMOS), a positive channel metal-oxide-semiconductor (PMOS), a bipolar junction transistor (BJT), a bipolar CMOS (BiCMOS), silicon germanium (SiGe), and gallium arsenide (GaAs).

The communication apparatus described in the foregoing embodiment may be a terminal device or a network device. However, a scope of the apparatus described in this disclosure is not limited thereto, and a structure of the communication apparatus may not be limited by that in FIG. 8. The apparatus may be an independent device, or may be a part of a larger device. For example, the communication apparatus may be:
(1) an independent IC, a chip, a chip system or subsystem;
(2) a set of one or more ICs, where optionally, the IC set may include a storage component configured to store data and/or instructions;
(3) an ASIC, for example, a modem;
(4) a module that can be embedded in another device; and
(5) the terminal device or the network device.

FIG. 9 is a diagram of a structure of a terminal device according to an embodiment of this disclosure. For ease of description, FIG. 9 shows only main components of the terminal device. As shown in FIG. 9, the terminal device 101 includes a processor, a memory, a control circuit, an antenna, and an input/output apparatus. The processor is mainly configured to: process a communication protocol and communication data, control the entire terminal device, execute a software program, and process data of the software program. The memory is mainly configured to store the software program and data. The radio frequency circuit is mainly configured to: perform conversion between a baseband signal and a radio frequency signal, and process the radio frequency signal. The antenna is mainly configured to receive and send a radio frequency signal in a form of an electromagnetic wave. The input/output apparatus, such as a touchscreen, a display, or a keyboard, is mainly configured to receive data input by a user and output data to the user.

After the terminal device is powered on, the processor may read a software program in a storage unit, parse and execute instructions of the software program, and process data of the software program. When data needs to be sent in a wireless manner, the processor performs baseband processing on the to-be-sent data, and outputs a baseband signal to the radio frequency circuit. The radio frequency circuit processes the baseband signal to obtain a radio frequency signal, and sends the radio frequency signal to the outside in an electromagnetic wave form by using the antenna. When data is sent to the terminal device, the radio frequency circuit receives the radio frequency signal through the antenna. The radio frequency signal is further converted into a baseband signal, and the baseband signal is output to the processor. The processor converts the baseband signal into data, and processes the data.

For ease of description, FIG. 9 shows only one memory and one processor. In an actual terminal device, there may be a plurality of processors and memories. The memory may also be referred to as a storage medium, a storage device, or the like. This is not limited in embodiments of this disclosure.

In an optional implementation, the processor may include a baseband processor and a central processing unit. The baseband processor is mainly configured to process the communication protocol and the communication data. The central processing unit is mainly configured to control the entire terminal device, execute the software program, and process the data of the software program. The processor in FIG. 9 integrates functions of the baseband processor and the central processing unit. Persons skilled in the art may understand that the baseband processor and the central processing unit may be independent processors, and are interconnected by using a technology such as a bus. Persons skilled in the art may understand that the terminal device may include a plurality of baseband processors to adapt to different network standards, and the terminal device may include a plurality of central processing units to enhance a processing capability of the terminal device, and components of the terminal device may be connected by using various buses. The baseband processor may alternatively be expressed as a baseband processing circuit or a baseband processing chip. The central processing unit may alternatively be expressed as a central processing circuit or a central processing chip. A function of processing the communication protocol and the communication data may be built in the processor, or may be stored in the storage unit in a form of a software program, and the processor executes the software program to implement a baseband processing function.

In an example, the antenna and the control circuit that have a transceiver function may be considered as a transceiver unit of the terminal device 101, and the processor having a processing function may be considered as a processing unit of the terminal device 101. The transceiver unit may also be referred to as a transceiver, a transceiver machine, a transceiver apparatus, or the like. Optionally, a component that is in the transceiver unit and that is configured to implement a receiving function may be considered as a receiving unit, and a component that is in the transceiver unit and that is configured to implement a sending function may be considered as a sending unit. In other words, the transceiver unit includes the receiving unit and the sending unit. For example, the receiving unit may also be referred to as a receiver, a receive machine, a receiving circuit, or the like, and the sending unit may also be referred to as a transmitter, a transmit machine, a transmitting circuit, or the like. Optionally, the receiving unit and the sending unit may be one integrated unit, or may be a plurality of independent units. The receiving unit and the sending unit may be in one geographical position, or may be distributed in a plurality of geographical positions.

In an embodiment, the transceiver unit is configured to perform operations performed by the sending unit 701 and the receiving unit 702 in the foregoing embodiment. The processing unit is configured to perform an operation performed by the processing unit 703 in the foregoing embodiment. The terminal device 101 may be further configured to perform any method performed by the terminal device or the network device in the method embodiment in FIG. 4. Details are not described herein again.

An embodiment of this disclosure further provides a computer-readable storage medium. The computer-readable storage medium stores a computer program. When the program is executed by a processor, a procedure related to the terminal device or the network device in the communication method provided in the foregoing method embodiments may be implemented.

An embodiment of this disclosure further provides a computer program product. When the computer program product is run on a computer or a processor, the computer or the processor is enabled to perform one or more steps in any one of the foregoing communication methods. When component modules of the foregoing device are implemented in a form of a software functional unit and sold or used as an independent product, the component modules may be stored in a computer-readable storage medium.

An embodiment of this disclosure further provides a chip, including a processor, configured to: invoke, from a memory, instructions stored in the memory, and run the instructions, to enable a communication apparatus in which the chip is installed to perform any one of the foregoing methods.

An embodiment of this disclosure further provides another chip, including an input interface, an output interface, and a processing circuit. The input interface, the output interface, and the circuit are connected by using an internal connection path, and the processing circuit is configured to perform any one of the foregoing methods. Optionally, the chip further includes a memory. The input interface, the output interface, a processor, and the memory are connected by using an internal connection path. The processor is configured to execute code in the memory. When the code is executed, the processor is configured to perform any one of the foregoing methods.

An embodiment of this disclosure further provides a chip system, including at least one processor and a communication interface. The communication interface and the at least one processor are interconnected through a line, and the at least one processor is configured to run a computer program or instructions, to perform any one of the foregoing methods. The chip system may include a chip, or may include a chip and another discrete component.

An embodiment of this disclosure further provides a communication system. The system includes a terminal device and a network device. For specific descriptions, refer to any method shown in FIG. 4.

The network device may include a first access network device, a second access network device, a core network device, and the like.

It should be understood that the memory mentioned in embodiments of this disclosure may be a volatile memory or a non-volatile memory, or may include both a volatile memory and a non-volatile memory. The non-volatile memory may be a hard disk drive (HDD), a solid-state drive (SSD), a read-only memory (ROM), a programmable read-only memory (PROM), an erasable programmable read-only memory (EPROM), an electrically erasable programmable read-only memory (EEPROM), or a flash memory. The volatile memory may be a random-access memory (RAM), used as an external cache. Through example but not limitative description, many forms of RAMs are available, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous-link dynamic random-access memory (SLDRAM), and a direct Rambus dynamic random-access memory (DR RAM). The memory is any other medium that can be configured to carry or store expected program code in a form of instructions or a data structure and that can be accessed by a computer. This is not limited thereto. The memory in embodiments of this disclosure may alternatively be a circuit or any other apparatus that can implement a storage function, and is configured to store the program instructions and/or the data.

It should be further understood that the processor mentioned in embodiments of this disclosure may be a CPU, or may be another general-purpose processor, a digital signal processor (DSP), an ASIC, a field-programmable gate array (FPGA) or another programmable logic device, a discrete gate or a transistor logic device, a discrete hardware component, or the like. The general-purpose processor may be a microprocessor, or the processor may be any other processor or the like.

It should be noted that when the processor is a general-purpose processor, a DSP, an ASIC, an FPGA or another programmable logic device, a discrete gate, a transistor logic device, or a discrete hardware component, the memory (a storage module) is integrated into the processor.

It should be noted that the memory described in this specification aims to include but is not limited to these memories and any memory of another proper type.

It should be understood that sequence numbers of the foregoing processes do not mean execution sequences in various embodiments of this disclosure. The execution sequences of the processes should be determined according to functions and internal logic of the processes, and should not be construed as any limitation on the implementation processes of embodiments of this disclosure.

Persons of ordinary skill in the art may be aware that units and algorithm steps in the examples described with reference to embodiments provided in this specification may be implemented by electronic hardware or a combination of computer software and electronic hardware. Whether the functions are performed by hardware or software depends on particular applications and design constraint conditions of the technical solutions. Persons skilled in the art may use different methods to implement the described functions for each particular application, but it should not be considered that the implementation goes beyond the scope of this disclosure.

In the several embodiments provided in this disclosure, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the mutual coupling or direct coupling or communication connection shown or discussed may be indirect coupling or communication connection through some interfaces, apparatuses, or units, and may be in electrical, mechanical, or other forms.

The units described as separate parts may or may not be physically separate, and parts displayed as units may or may not be physical units, that is, may be located in one position, or may be distributed on a plurality of network units. Some or all of the units may be selected based on actual requirements to achieve the objectives of the solutions of embodiments.

In addition, functional units in embodiments of this disclosure may be integrated into one processing unit, or each of the units may exist alone physically, or two or more units may be integrated into one unit.

When functions are implemented in the form of a software functional unit and sold or used as an independent product, the functions may be stored in a computer-readable storage medium. Based on such an understanding, the technical solutions of this disclosure essentially, or the part contributing to the technology, or some of the technical solutions may be implemented in a form of a software product. The computer software product is stored in a storage medium, and includes several instructions for instructing a computer device (which may be a personal computer, a server, or a network device) to perform all or some of the steps of the methods described in embodiments of this disclosure. The foregoing storage medium includes any medium that can store program code, such as a Universal Serial Bus (USB) flash drive, a removable hard disk, a ROM, a RAM, a magnetic disk, or an optical disc.

A sequence of the steps of the method in embodiments of this disclosure may be adjusted, combined, or removed based on an actual requirement. Steps in each embodiment may be partially performed (for example, the terminal device may not perform the steps performed by the terminal device in the foregoing embodiments). An execution sequence of different steps can be changed. Embodiments described in this specification may be combined with other embodiments, different embodiments may be combined with each other, and different steps of different embodiments in this specification may be combined.

The modules/units in the apparatuses in embodiments of this disclosure may be combined, divided, and deleted based on an actual requirement.

An “embodiment” mentioned in this specification means that a particular feature, structure, or characteristic described with reference to this embodiment may be included in at least one embodiment of this disclosure. The phrase shown in various locations in this specification may not necessarily refer to a same embodiment, and is not an independent or optional embodiment exclusive from another embodiment.

Terms “first”, “second”, “third”, “fourth”, and the like (if any) in embodiments of this disclosure are intended to distinguish between similar objects, but do not necessarily indicate a specific order or sequence.

In embodiments of this disclosure, “include” may be an inclusion relationship, or may be an equal relationship. For example, if A includes B, A may include other content in addition to B, or A and B are the same content.

In descriptions of this disclosure, unless otherwise specified, “/” indicates an “or” relationship between associated objects. For example, A/B may indicate A or B. In this disclosure, “and/or” describes only an association relationship between associated objects and indicates that three relationships may exist. For example, A and/or B may indicate three cases: only A exists, both A and B exist, or only B exists, where A and B may be singular or plural. In addition, in the descriptions of this disclosure, “a plurality of” means two or more than two unless otherwise specified. “At least one of the following” or a similar expression thereof means any combination of these items, including a singular item or any combination of plural items. For example, at least one of a, b, or c may represent a, b, c, a and b, a and c, b and c, or a, b, and c, where a, b, and c may be singular or plural.

In conclusion, the foregoing embodiments are merely intended for describing the technical solutions of this disclosure, but not for limiting this disclosure. Although this disclosure is described in detail with reference to the foregoing embodiments, persons of ordinary skill in the art should understand that they may still make modifications to the technical solutions described in the foregoing embodiments or make equivalent replacements to some technical features thereof, without departing from the scope of the corresponding technical solutions of embodiments of this disclosure.

1. A method, comprising:
receiving, from a first access network device or a core network device, a first configuration comprising a positioning parameter of a first reference signal;
receiving, from the first access network device, a second reference signal;
receiving, from a second access network device, a third reference signal; and
sending, based on the first configuration, the second reference signal, and the third reference signal and to the core network device, a time difference of arrival between the second reference signal and the third reference signal.

2. The method of claim 1, wherein the positioning parameter comprises at least one of a first quantity of cyclically shifted bits, a second quantity of bits of each frame cyclically shifted relative to a previous frame, or an offset value in a frequency domain.

3. The method of claim 2, wherein the first quantity is greater than a timing drift of the first reference signal.

4. The method of claim 1, wherein the positioning parameter is related to at least one of a frame number or an index.

5. The method of claim 1, further comprising determining, based on a first receiving time of the second reference signal, a second receiving time of the third reference signal, and a second configuration, the time difference, wherein the second configuration comprises a mapping relationship between fourth reference signals from the first access network device and the second access network device, and wherein the second configuration is predefined, preconfigured, from the first access network device, or from the core network device.

6. The method of claim 1, further comprising receiving, from the first access network device or the core network device, a third configuration comprising a frame-level offset value between the first access network device and the second access network device.

7. An apparatus, comprising:
one or more memories configured to store program instructions; and
one or more processors coupled to the one or more memories and configured to execute the program instructions to cause the apparatus to:
receive, from a first access network device or a core network device, a first configuration comprising a positioning parameter of a first reference signal;
receive, from the first access network device, a second reference signal;
receive, from a second access network device, a third reference signal; and
send, based on the first configuration, the second reference signal, and the third reference signal and to the core network device, a time difference of arrival between the second reference signal and the third reference signal.

8. The apparatus of claim 7, wherein the positioning parameter comprises at least one of a first quantity of cyclically shifted bits, a second quantity of bits of each frame cyclically shifted relative to a previous frame, or an offset value in a frequency domain.

9. The apparatus of claim 8, wherein the first quantity is greater than a timing drift of the first reference signal.

10. The apparatus of claim 7, wherein the positioning parameter is related to at least one of a frame number or an index.

11. The apparatus of claim 7, wherein the one or more processors are further configured to execute the program instructions to cause the apparatus to determine, based on a first receiving time of the second reference signal, a second receiving time of the third reference signal, and a second configuration, the time difference, wherein the second configuration comprises a mapping relationship between fourth reference signals from the first access network device and the second access network device, and wherein the second configuration is predefined, preconfigured, from the first access network device, or from the core network device.

12. The apparatus of claim 7, wherein the one or more processors are further configured to execute the program instructions to cause the apparatus to receive, from the first access network device or the core network device, a third configuration comprising a frame-level offset value between the first access network device and the second access network device.

13. An apparatus, comprising:
one or more memories configured to store program instructions; and
one or more processors coupled to the one or more memories and configured to execute the program instructions to cause the apparatus to:
send, to a terminal device, a first configuration comprising a positioning parameter of a first reference signal from at least one of a first access network device or a second access network device; and
receive, from the terminal device, a time difference of arrival between a second reference signal and a third reference signal,
wherein the second reference signal is from the first access network device, and
wherein the third reference signal is from the second access network device.

14. The apparatus of claim 13, wherein the positioning parameter comprises a quantity of cyclically shifted bits.

15. The apparatus of claim 14, wherein the quantity is greater than a timing drift of the first reference signal.

16. The apparatus of claim 13, wherein the positioning parameter is related to at least one of a frame number or an index.

17. The apparatus of claim 13, wherein the one or more processors are further configured to execute the program instructions to cause the apparatus to send, to the terminal device, a second configuration comprising a mapping relationship between fourth reference signals from the first access network device and the second access network device.

18. The apparatus of claim 13, wherein the one or more processors are further configured to execute the program instructions to cause the apparatus to send, to the terminal device a third configuration comprising a frame-level offset value between the first access network device and the second access network device.

19. The apparatus of claim 13, wherein the positioning parameter comprises a quantity of bits of each frame cyclically shifted relative to a previous frame.

20. The apparatus of claim 13, wherein the positioning parameter comprises an offset value in a frequency domain.
